(19) United States
(12) Patent Application Publication
(10) Pub. No.: US 2024/0060356 A1
(43) Pub. Date: Feb. 22, 2024

(54) MODULAR BARRIER PANEL FRAME REINFORCEMENT SYSTEMS AND METHODS

(71) Applicant: OVERHEAD DOOR CORPORATION, Lewisville, TX (US)

(72) Inventor: Bradley J. Lee, Arlington, TX (US)

(21) Appl. No.: 17/889,195

(22) Filed: Aug. 16, 2022

(51) Int. Cl. E06B 3/48; E05D 15/24; E06B 3/04

(52) U.S. Cl. CPC E06B 3/485; E05D 15/242; E06B 3/04; E05Y 2900/106

(57) ABSTRACT

A frame rail for a movable barrier includes a top side, a bottom side, a front side, and a rear side. A first module connector is formed on the rear side. The first module connector extends continuously along a length of the frame rail and is configured to slidably receive a corresponding second module connector of a module. The frame rail has a continuous cross-section with the first module connector integrally formed with the top, bottom, front, and rear sides. One of the first or second module connectors comprises a groove and the other of the first or second module connectors comprises a tongue configured for receipt within the groove. The first module connector is configured to slidably receive the second module connector from a longitudinal end surface of the frame rail.

### TECHNICAL FIELD

The present disclosure relates generally to the field of movable barriers. In particular, a panel frame of a barrier is modular and includes a frame rail configured to receive interchangeable reinforcement modules.

### BACKGROUND

Multi-panel doors of the type used for closing a large opening in a building, such as a garage door, have long been manufactured using a plurality of substantially identical panels. The plurality of panels may be pivotally connected together to permit relative hinging movement between adjacent panels when the door is moved between a vertical closed position and a horizontal open position.

Such multi-panel doors are commonly referred to as upward-acting sectional doors and often include panels formed of a shell or casing, such as a molded, roll formed and/or stamped piece of metal, fiberglass, or plastic, and an insulating core. In some cases, a multi-panel door includes glazing (e.g., windows) positioned within one or more of the panels to allow users to view through a portion of the door. Some such multi-panel doors are full view doors intended to provide a high ratio of glazing area to frame area, thereby providing a minimally obstructed view through the door. Panels of such full view doors may be constructed from a low-profile metal frame (e.g., aluminum) with a glazing panel disposed within an opening of the frame.

In full view doors that are designed to maximize the ratio of glazing area versus frame area, a basic low-profile panel frame may be insufficient to meet impact rating criteria and resist high wind loads against the frame and glazing panel. Furthermore, the width of a door and/or the weight of the glazing panels may necessitate stronger frames. While frame members (e.g., rails and stiles) around the glazing panels could be constructed of a thicker cross-section or of a stronger material, such modification may negatively affect the aesthetic appearance of the door and substantially increase its weight. Rather, panels may be provided with a structural member formed integrally with the panel frame or fastened to the panel frame to reduce its flexibility and increase is resistance to deforming under high wind and impact loads. However, different levels of structural reinforcement may be required in different portions of the door. That is, loads experienced in one region of a door may be higher than loads experienced in other regions of the door, thereby requiring different levels of structural reinforcement. Accordingly, a single door is often constructed from a variety of different types of frame members having different structural properties to accommodate different design loads which requires complicated manufacturing processes and an increased inventory complexity to manage a wide array of frame members. Further, add-on structural reinforcement such as steel struts are unsightly and require a large number of fasteners which are visible from the rear side of the door. For example, U.S. Pat. No. 5,749,407 issued May 12, 1998 describes a reinforcing strut that attached to a garage door with self-tapping screws through flanges extending from the strut. U.S. Pat. No. 7,299,853 issued Nov. 27, 2007 similarly describes reinforcing struts that are fastened to door panels with sheet metal screws, self-drilling screws (tek screws), thread forming screws, and/or lag screws.

Accordingly, a need exists for an improved multi-panel door that retains the aesthetics of a full view design and simplifies manufacturing and assembly while satisfying design load criteria.

### SUMMARY

In an aspect, a frame rail for a movable barrier may include a top side, a bottom side, a front side, and a rear side. The frame rail may further include a first module connector formed on the rear side. The first module connector may extend continuously along a length of the frame rail and be configured to slidably receive a corresponding second module connector of a module.

In some examples, a frame rail may include a third module connector formed on the rear side. The third module connector may extend continuously along the length of the frame rail parallel to the first module connector. The third module connector may be configured to slidably receive a corresponding fourth module connector of the module.

In some examples, a frame rail may have a continuous cross-section with the first module connector integrally formed with the top, bottom, front, and rear sides. A frame rail may be formed as an extrusion.

In some examples, one of the first or second module connectors may be a groove and the other of the first or second module connectors may be tongue configured for receipt within the groove. The groove and the tongue may be shaped as a dovetail in cross-section. A first module connector may be configured to slidably receive the second module connector from a longitudinal end surface of the frame rail

In another aspect, a movable barrier may include a plurality of interconnected panels and a first module. A first panel of the plurality of interconnected panels may include a first frame rail, a second frame rail, and at least one stile connecting the first frame rail and the second frame rail. The first frame rail may include a top side, a bottom side, a front side, and a rear side with a first module connector formed on the rear side. The first module connector may extend continuously along a length of the first frame rail. The first module may include a second module connector configured to slidably engage the first module connector to secure the first module to the first panel.

In some examples, the first module may include a reinforcing fin configured to resist flexing of the first panel. One of the first or second module connectors may include a groove and the other of the first or second module connectors may include a tongue configured for receipt within the groove.

In some examples, the first frame rail may further include a third module connector formed on the rear side. The third module connector may extend continuously along the length of the first frame rail parallel to the first module connector. The first module may further include a corresponding fourth module connector configured to slidably engage the third module connector to secure the first module to the first panel. The first module connector and the third module connector may each include a groove and the second module connector and the fourth module connector may each include a corresponding tongue. The first module connector and the third module connector may each include a tongue and the second module connector and the fourth module connector may each include a corresponding groove.

In some examples, the first module may include a reinforcing strut configured to resist bending of the first panel. A strut may include a chamber enclosed in cross-section extending along a length of the strut. A strut may include a support wall positioned in the chamber and extending between a top wall of the strut and a bottom wall of the strut. A strut may include an internal support member slidably receivable within the chamber.

In some examples, a second frame rail may include a top side, a bottom side, a front side, and a rear side with a third module connector formed on the rear side of the second frame rail. The third module connector may extend continuously along a length of the second frame rail. A movable barrier may include a second module including a fourth module connector configured to slidably engage the third module connector to secure the second module to the first panel. A movable barrier may include a glazing member positioned within an opening formed by a first frame rail, a second frame rail, a first stile, and a second stile.

In another aspect, a method of assembling a movable barrier may include forming a plurality of panels. Each panel of the plurality of panels may include an opening defined between a first frame rail, a second frame rail, a first stile connecting the first and second frame rails, and a second stile connecting the first and second frame rails. A first frame rail may include a top side, a bottom side, a front side, and a rear side with a module connector formed on the rear side. The module connector may extend continuously along a length of the first frame rail.

In some examples, a method of assembling a movable barrier may include positioning a glazing member in the opening of each panel and connecting each panel to one or more adjacent panels of the plurality of panels. A method of assembling a movable barrier may include coupling a first module to a first panel of the plurality of panels by slidably engaging a module connector of the first module with the module connector of the first frame rail of the first panel. Such a method may also include coupling a second module to a second panel of the plurality of panels by slidably engaging a module connector of the second module with the module connector of the first frame rail of the second panel.

In some examples, the first module may have a different cross-sectional profile than the second module.

In some examples, coupling the first module to the first panel of the plurality of panels may include slidably engaging a second module connector of the first module with a second module connector of the first frame rail of the first panel.

It is to be understood that both the foregoing general description and the following drawings and detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following. One or more features of any implementation or aspect may be combinable with one or more features of other implementation or aspect.

### BRIEF DESCRIPTION OF THE DRAWINGS

The accompanying drawings illustrate implementations of the systems, devices, and methods disclosed herein and together with the description, serve to explain the principles of the present disclosure.

FIG. 1 is a front view of an example of a multi-panel door in accordance with the present disclosure.

FIG. 2 is a rear view of the example of a multi-panel door of FIG. 1.

FIG. 3 is a rear view of a portion of a panel of the multi-panel door of FIG. 2.

FIG. 4 is a cross-section view of an example of a multi-panel door in accordance with the present disclosure.

FIG. 5 is a cross-section view of an example of a frame rail in accordance with the present disclosure.

FIG. 6 is a cross-section view of a door panel including the example of a frame rail of FIG. 5.

FIGS. 7-12 illustrate various examples of modules, in accordance with the present disclosure, for attachment to the example of a frame rail of FIG. 5.

FIG. 13 is a flow-chart of an example method of assembling a movable barrier in accordance with present disclosure.

These Figures will be better understood by reference to the following Detailed Description.

### DETAILED DESCRIPTION

For the purpose of promoting an understanding of the principles of the present disclosure, reference will now be made to the implementations illustrated in the drawings and specific language will be used to describe them. It will nevertheless be understood that no limitation of the scope of the disclosure is intended. Any alterations and further modifications to the described devices, instruments, methods, and any further application of the principles of the present disclosure are fully contemplated as would normally occur to one skilled in the art to which the disclosure relates. In addition, this disclosure describes some elements or features in detail with respect to one or more implementations or Figures, when those same elements or features appear in subsequent Figures, without such a high level of detail. It is fully contemplated that the features, components, and/or steps described with respect to one or more implementations or Figures may be combined with the features, components, and/or steps described with respect to other implementations or Figures of the present disclosure. For simplicity, in some instances the same or similar reference numbers are used throughout the drawings to refer to the same or like parts.

The present disclosure is directed to door systems and methods of manufacture and assembly. The systems and methods described herein may provide for multi-panel sectional doors that satisfy impact rating criteria for storm prone regions. The concepts of the present disclosure may be suited for aluminum full view doors in which a majority of the exposed front surface and/or rear surface of the door is transparent or translucent by providing for low-profile frame rails with reinforcement modules.

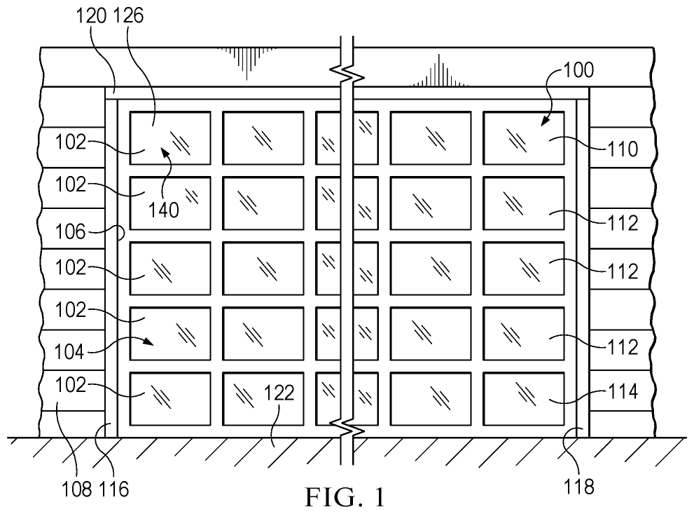

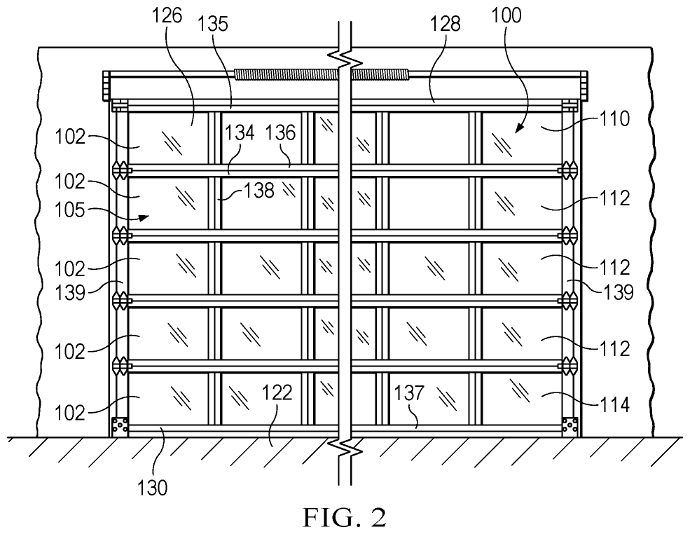

FIGS. 1-2 illustrate an example of an upward-acting multi-panel door 100 which may be rated for hurricane and other storm prone areas such that the door 100 is wind and impact resistant, while still providing a full view through the door 100. The door 100 includes a top panel 110, a plurality of intermediate panels 112, and a bottom panel 114 (collectively, panels 102) that together form a front face 104 and a rear face 105 of the door 100. In the example illustrated in FIG. 1, the plurality of panels 102 are interconnected by hinges to cover an opening 106, in a building 108 or other structure, typically defined by two jambs 116, 118, a header 120, and a floor 122 (e.g., a driveway). In other examples, the door 100 may include any number of intermediate panels 112 and may be located in any suitable opening 106. For example, the door 100 may include the top panel 110, one intermediate panel 112, and the bottom panel 114. The panels may be mounted on conventional track with rollers within a structure to enable movement of the door 100 between the vertical (closed) position shown in FIGS. 1-2, and a horizontal (e.g., open or overhead) position. In the vertical position, a bottom seal 130 may rest against the floor 122 and a top seal 128 may rest against or adjacent to the header 120.

Each of the panels may be formed of rails and stiles. The top panel 110 is defined by a top frame rail 135, an intermediate bottom frame rail 136, and opposing outer stiles 139 at each end thereof. Each intermediate panel 112 is defined by an intermediate top frame rail 134, an intermediate bottom frame rail 136, and opposing outer stiles 139 at each end thereof. The bottom panel 114 is defined by an intermediate top frame rail 134, a bottom frame rail 137, and opposing outer stiles at each end thereof. For the sake of clarity, each of the intermediate top frame rail 134, top frame rail 135, intermediate bottom frame rail 136, and bottom frame rail 137 may be referred to herein as a “frame rail.” A plurality of intermediate stiles 138 may extend between the respective top and bottom frame rails of each panel, with generally rectangular openings 140 formed between adjacent stiles. Although illustrated as rectangular openings 140, it should be appreciated that other suitable shapes may be utilized in other examples. A sheet of material or glazing member 126 may be disposed within each opening 140.

It should be appreciated that any number of intermediate stiles 138 may be used. In some examples, a panel may include no intermediate stiles and may form a single opening 140 between a top and bottom frame rail and a left and right outer stile with a single glazing member 126 extending the full width of the opening.

In some examples, the rails and stiles are formed as aluminum extrusions that are coupled together to form a panel frame. It should be appreciated that other metals or other materials (e.g., plastics) can be used to construct the frame members. In some examples, all of the rails have the same cross-sectional profile shape and may be formed from a common segment of extruded material cut to length. In some examples, three rail types are used with the intermediate top frame rails 134 having a first cross-sectional profile shape, the intermediate bottom frame rails 136 having a second cross-sectional profile shape, and the top and bottom frame rails 135, 137 having a third cross-sectional profile shape. In some examples, the intermediate top and bottom frame rails 134, 136 may have the same cross-sectional profile shape and the top frame rail 135 and bottom frame rail 137 may have a different cross-sectional profile shape.

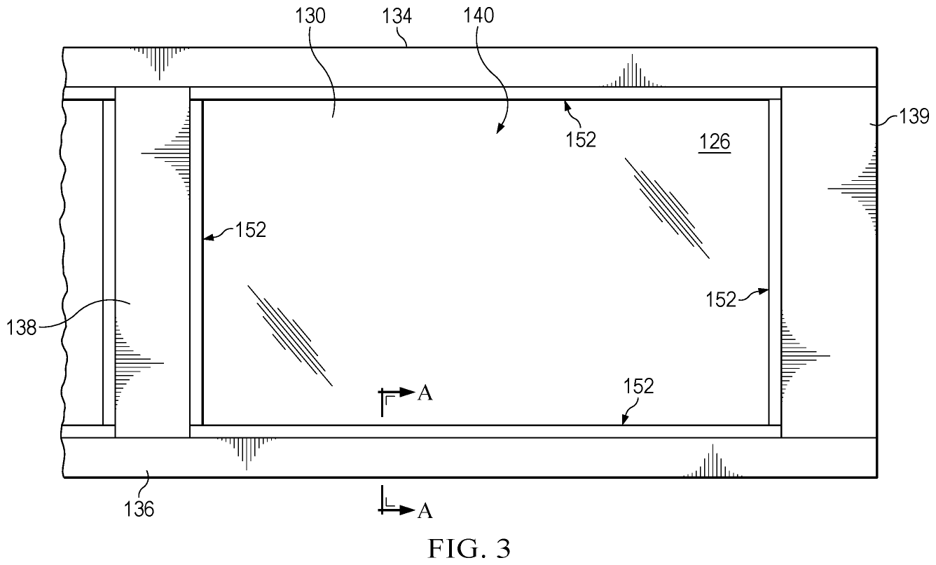

FIG. 3 illustrates rear view of a portion of a panel 102 of the multi-panel door 100 of FIG. 2. The panel of FIG. 3 is an intermediate panel 112 having an intermediate top frame rail 134, an intermediate bottom frame rail 136, an outer stile 139, and an intermediate stile 138 forming an opening 140 in which a glazing member 126 is positioned. Retainer members 152 are disposed around the perimeter of the opening 140 and secured to the respective frame rails and stiles to retain the glazing member 126 in the opening 140. Additional details regarding examples of retainer members may be found in U.S. patent application Ser. No. 17/720,051 filed Apr. 13, 2022 (disclosing “Glazing Retainer for Impact Rated Doors”). Each glazing member 126 may be made of any suitable material and may be opaque, translucent, semi-translucent, transparent, semi-transparent or a combination of any of the foregoing. For example, in some examples the glazing members 126 are made of semi-translucent black, white, bronze or mirror silver glass. In other examples, the glazing members 126 are made of an opaque metal material. In yet other examples, the glazing members 126 are made of tempered glass that has flame-polished edges to prevent chipping or cracking. In some examples, the glazing members 126 are made of polycarbonate. In some examples, the glazing members 126 are rated for use in hurricane prone areas, such as the state of Florida in the United States of America, so that the glazing members 126 are capable of withstanding high wind loads and missile impact from debris. Moreover, the glazing members 126 may meet the rating standards set by state or governmental entities in said hurricane prone areas.

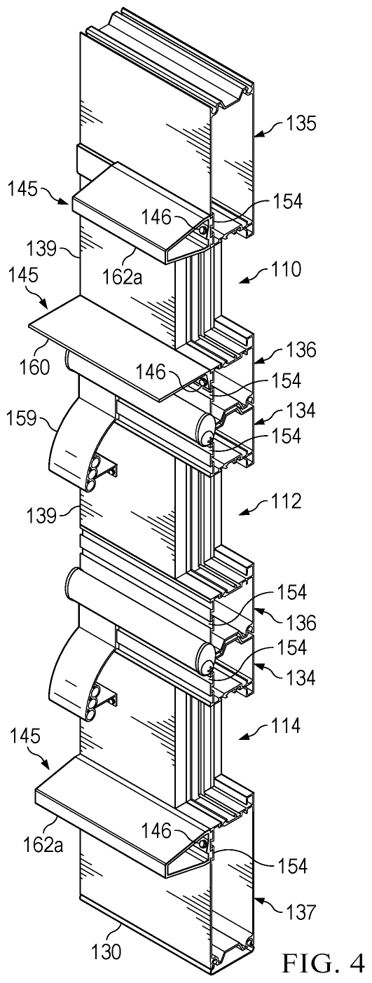

Turning to FIG. 4, a section through an example of a multi-panel door is shown. A horizontal force caused by wind or impact against the outer surface of a door 100 will tend to push the door rearward. Additionally, larger doors with heavy glazing members may cause a substantial downward force on each successively lower panel. Such forces may tend to cause the door 100 to flex. To prevent this deformation, one or more panels may be modularly reinforced by the addition of one or more reinforcement modules 145.

Typically, door manufacturers will produce a wide array of different rail types, each being suitable for particular design loads. Different rail types may have different rail heights, standard rails without reinforcement, rails with short fin reinforcement, rails with long fin reinforcement, etc. Standard rails may be reinforced during assembly with steel struts or structural angle, and in some instances rails with integrated fins are further reinforced with steel struts. The width of a door, the height of a door, the type of glazing members used, and the geographic location of a door may all play into determining the level of reinforcement required for a particular door. Moreover, different levels of reinforcement may be required within a single door, with certain panels requiring more reinforcement than others. Tooling the various extrusion profiles for different rail types is costly and inefficient and requires complex inventory management to ensure each different type of rail is available.

Fins are typically extruded as an integral portion of a frame rail. If additional reinforcement is necessary to support the frame, steel struts are attached to the frame rails with fasteners secured through legs on the strut. Steel sheet metal struts are not as aesthetically pleasing as the aluminum extruded reinforcement modules discussed herein, in part due to the roll-form manufacturing process required to make the struts and the limitations of the finishing options. Further, securing such struts to the frame rails leaves screws exposed which are also unsightly.

The present disclosure addresses these problems by utilizing a modular frame rail that can be modified to suit a wide range of installation uses with modules that attach to the frame rails. The interchangeability of modules allows for varying strength applications of a single type of frame rail. With the modular design discussed herein, each door panel frame may be configured with one or both frame rails having the same cross-sectional profile. In an example, all of intermediate panels of a door may be constructed from the same two frame rail types, an intermediate top frame rail and an intermediate bottom frame rail. In this regard, the frame rails of all intermediate panels in a door may be cut from two lengths of extruded rail. The top frame rail of the door on the top panel and the bottom frame rail on the bottom panel may also be cut from a common length of extruded rail, different than the intermediate frame rails to accommodate a door seal. In this regard, only three different rail types may be needed for assembling a door. Modules in the form of struts or fins, for example, may be added to these frame rails during assembly as needed for a particular application based on anticipated design loads and glazing weights, allowing doors to be structurally reinforced on the fly. In some implementations, the modules are structural components that can project from the rails or stiles for particular purposes. The modules may add structural integrity, act as couplers or fasteners, may serve as connection points or as spacers or as other structural component. This module design may substantially reduce the number of SKUs or part models needed to construct a typical door.

The example door 100 illustrated in FIG. 4 includes a top panel 110, an intermediate panel 112, and a bottom panel 114. The top panel 110 includes a top frame rail 135 and an intermediate bottom frame rail 136 connected by an outer stile 139. The top frame rail 135 includes a pair of module connectors along its rear side in the form of two grooves 154 configured to engage a pair of corresponding module connectors in the form of two tongues of a module 145. In the illustrated example, the module 145 is a strut module 162a configured to reinforce the top panel 110. The strut module 162a extends across all or a majority of the length of the top frame rail 135. In the illustrated example, a module in the form of a roller holder 159 is engaged with the module connectors of the top frame rail 135 at each end and are configured to support a roller shaft and wheel to guide the door along a track. In this regard, any number of modules may be engaged with the module connectors of the top frame rail. It should be appreciated that more or fewer module connectors may be provided on the top frame rail 135 and strut module 162a. In some examples, the roller holder 159 may be engaged with different module connectors on the top frame rail 135 than the strut module 162a. Further, module connectors may be provided at any suitable location on the top frame rail 135 for receiving one or more modules. The intermediate bottom frame rail 136 includes a pair of module connectors along its rear side in the form of two grooves 154 configured to engage a pair of corresponding module connectors in the form of two tongues of another module 145. In the illustrated example, the module 145 attached to the intermediate bottom frame rail 136 of the top panel 110 is a fin module 160 configured to reinforce the top panel 110. The fin module 160 extends across all or a majority of the length of the intermediate bottom frame rail 136. Any number of additional modules may be engaged with the module connectors of the intermediate bottom frame rail 136. It should be appreciated that more or fewer module connectors may be provided on the intermediate bottom frame rail 136 and fin module 160. Further, module connectors may be provided at any suitable location on the intermediate bottom frame rail 136 for receiving one or more modules.

The intermediate panel 112 includes an intermediate top frame rail 134 and an intermediate bottom frame rail 136 connected by an outer stile 139. The intermediate top frame rail 134 includes a pair of module connectors along its rear side in the form of two grooves 154 configured to engage a pair of corresponding module connectors of a module. In the illustrated example, a module in the form of a roller holder 159 is engaged with the module connectors of the intermediate top frame rail 134. The intermediate bottom frame rail 136 also includes a pair of module connectors along its rear side in the form of two grooves 154 configured to engage a pair of corresponding module connectors of a module. In the illustrated example, there are no modules 145 engaged with the intermediate bottom frame rail 136. Any number of modules may be engaged with the module connectors of the intermediate top frame rail 134 and/or intermediate bottom frame rail 136. For example, a fin or strut could be secured to one or both of the intermediate top frame rail 134 or intermediate bottom frame rail 136. It should be appreciated that more or fewer module connectors may be provided on the intermediate top frame rail 134 and/or intermediate bottom frame rail 136. Further, module connectors may be provided at any suitable location on the frame rails for receiving one or more modules.

The bottom panel 114 includes an intermediate top frame rail 134 and a bottom frame rail 136 connected by an outer stile 139. The intermediate top frame rail 134 of the bottom panel 114 includes a pair of module connectors along its rear side in the form of two grooves 154 configured to engage a pair of corresponding module connectors in the form of two tongues of a module 145 (not shown), which may include a strut module configured to reinforce the bottom panel 114. Any number of modules may be engaged with the module connectors of the intermediate top frame rail of the bottom panel 114. It should be appreciated that more or fewer module connectors may be provided on the intermediate top frame rail 134. Further, module connectors may be provided at any suitable location on the intermediate top frame rail 134 for receiving one or more modules. The bottom frame rail 137 includes a pair of module connectors along its rear side in the form of two grooves 154 configured to engage a pair of corresponding module connectors in the form of two tongues of another module 145. In the illustrated example, the module 145 attached to the bottom frame rail 137 is a strut module 162a configured to reinforce the bottom panel 114. The strut module 162a extends across all or a majority of the length of the bottom frame rail 137. Any number of additional modules may be engaged with the module connectors of the bottom frame rail 137. It should be appreciated that more or fewer module connectors may be provided on the bottom frame rail 137 and strut module 162a. Further, module connectors may be provided at any suitable location on the bottom frame rail 137 for receiving one or more modules.

It is contemplated that any of the modules 145 described herein may be retained in engagement with a frame rail by their respective module connectors alone, without the need for additional fasteners. However, to improve securement of a module 145, one or more fasteners 146 may be used to secure the module 145 to a frame rail, which may be advantageous to prevent lateral translation of a module along the door. The fasteners may be positioned in apertures pre-formed through a module or may be self-tapping to create an aperture in a desired location. The fasteners may extend through a module 145 and into the respective frame rail.

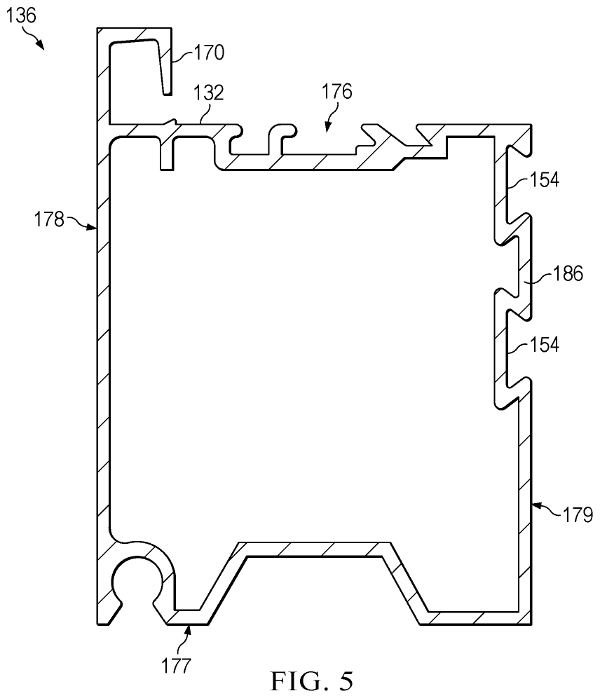

Turning to FIG. 5, an example of an intermediate bottom frame rail 136 is illustrated. Although shown and described in relation to an intermediate bottom frame rail 136, it should be appreciated that the principles discussed in relation to FIG. 5 are similarly applicable to a top frame rail 135, an intermediate top frame rail 134, and/or a bottom frame rail 137. Intermediate bottom frame rail 136 has a top side 176, a bottom side 177, a front side 178 and a rear side 179. The top side 176 includes a ledge extending partially between the front side 178 and the rear side 179 that is configured to support a glazing member 126. A lip 170 extends from the top side 176 and includes a portion that is substantially vertical. The lip 170 may form a barrier that the glazing member rests against or is secured to in order to retain the glazing member 126 in the opening 172. The bottom side 177 includes a recess. An adjacent intermediate top panel may include a corresponding protrusion configured to nest in the recess in the bottom side 177.

The rear side 179 of the intermediate bottom frame rail 136 includes two module connectors in the form of grooves 154. The grooves 154 may be continuously elongated to extend along the entire length of the rear side 179 or continuously elongated to extend along only a portion of a length of the rear side. Accordingly, in some aspects, the grooves 154 may extend only along the lateral side regions, but not in the central region.

It should be appreciated that the illustrated frame rail 136 of FIG. 5 is provided as an example and any number of changes to the geometry of the rail 136 may be made without departing from the scope of this disclosure.

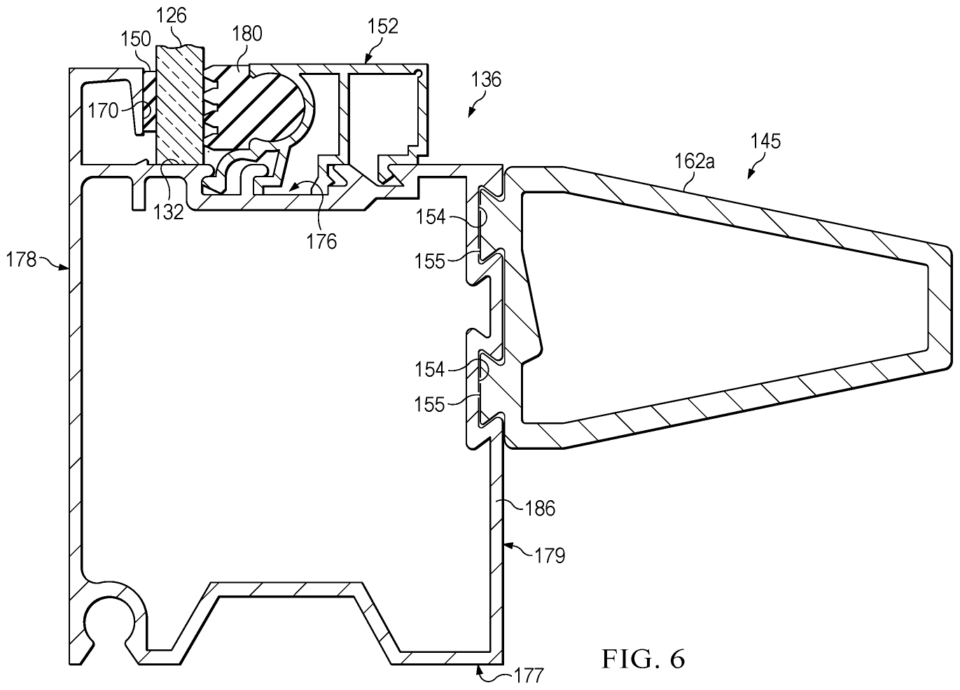

FIG. 6 illustrates a cross-section through an intermediate bottom frame rail 136 of an assembled panel taken along line A-A shown in FIG. 3 and including the example of a frame rail shown in FIG. 5. A glazing member 126 may be positioned on the ledge 132 with a coupling mechanism 150 positioned between the lip 170 and glazing member 126. A retainer member 152 may be snapped into place on the top side of the frame rail 136 to hold the glazing member 126 in place. A seal 180 may be positioned between the retainer member 152 and the glazing member 126.

A module 145 may be secured to the rear side 179 of the frame rail 136. In the illustrated example, the module 145 is a strut module 162a which is described in additional detail below. The module 145 includes two module connectors in the form of tongues 155 corresponding in shape and size to the two module connectors in the form of grooves 154 in the frame rail 136. The module 145 may be attached to the frame rail 136 by aligning an end of the tongues 155 with an end of the grooves 154, for example, at a lateral side of the frame rail 136, and sliding the module 145 along the length of the frame rail 136 until the module 145 is appropriately positioned. The grooves 154 may have a shape that retains the tongues 155 within the grooves 154 such that additional securement mechanisms are not needed. In the illustrated example, the tongues 155 and grooves 154 have a dovetail shape. That is, the grooves 1154 have a narrow opening with a wider profile inside the grooves than at the openings of the grooves 154 in the rear surface of the frame rail 136. In this regard, the tongues 155, having a corresponding shape, cannot be pulled from the grooves 154 but can only be installed and removed by sliding the module 145 laterally along the grooves 154. In some applications, one or more fasteners may be installed through the module 145 and into the frame rail 136 to prevent lateral translation of the module 145 with respect to the frame rail.

It should be appreciated that the module connectors of the frame rail 136 and module 145 can be reversed in some examples. That is, the tongues 155 may protrude from the rear side 179 of the frame rail 136 and the grooves 154 may extend into the module 145. Further, while the illustrated example includes two module connectors on each of the frame rail 136 and module 145, more or fewer module connector may be provided on one or both. In some examples, a frame rail 136 may have two module connectors and a module 145 may have only one module connector.

It should be appreciated that the illustrated frame rail 136 and module 145 of FIG. 6 are provided as an example and any number of changes to the geometry of the frame rail 136 and module 145 may be made without departing from the scope of this disclosure. Furthermore, the principles described in relation to the intermediate bottom frame rail 136 in FIGS. 5-6 are similarly applicable to top frame rails 135, intermediate top frame rails 134, and bottom frame rails 137. For example, any type of frame rail described herein may include one or more module connectors such as the grooves 154 or tongues 155 of FIGS. 5-6.

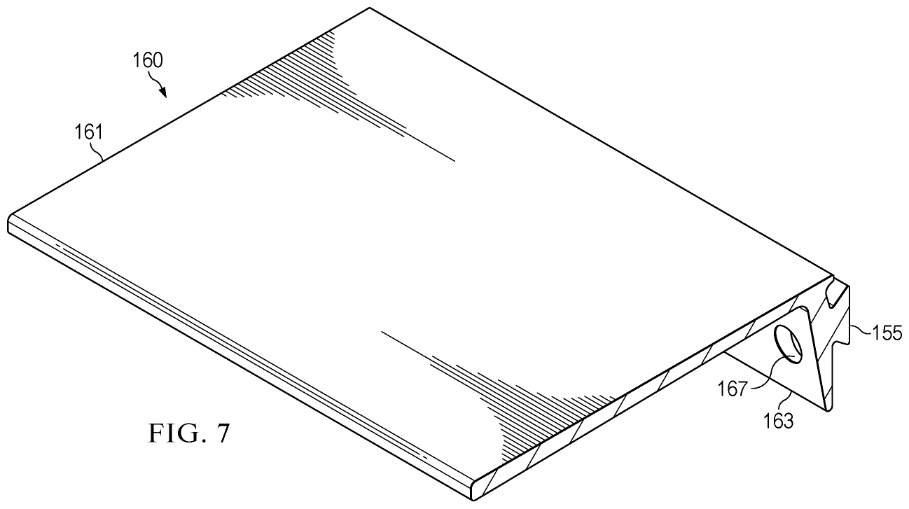

FIGS. 7-13 illustrate examples of modules 145 that may be secured to any type of frame rail discussed herein. FIG. 7 illustrates a module 145 in the form of a fin module 160, which may be similar to the fin module 160 of FIG. 4. The fin module 160 includes an attachment wall 163 which includes a module connector in the form of a tongue 155. The tongue 155 may be sized and shaped for receipt in a corresponding module connector in the form of a groove in a frame rail. In some examples, the attachment wall 163 of the fin module 160 may be lengthened to include two module connectors, such as two tongues 155, or may have one or more module connectors in the form a groove configured to receive a corresponding tongue of a frame rail. One or more fastener apertures 167 may extend through the attachment wall 163 for receiving a fastener to secure the module 145 to a respective frame rail. Fastener apertures 167 may be pre-formed in the attachment wall 163 during manufacturing of the fin module 160 or they may be created by a user in a desired location during assembly of a door.

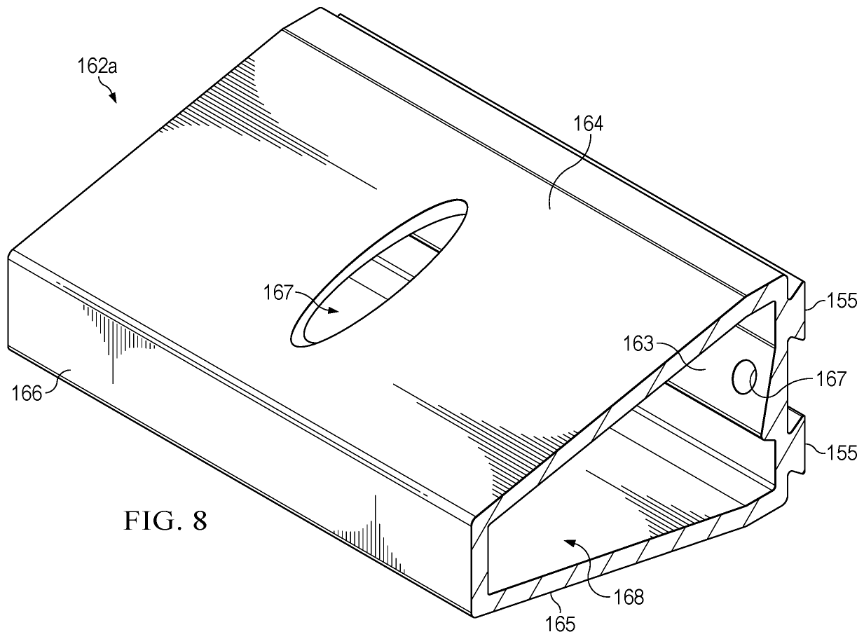

FIG. 8 illustrates a module 145 in the form of a strut module 162a, which may be similar to the strut module 162a of FIG. 4. The strut module 162a includes an attachment wall 163 which includes module connectors in the form of tongues 155. The tongues 155 may each be sized and shaped for receipt in a corresponding module connector in the form of a groove in a frame rail. In some examples, the attachment wall 163 of the strut module 162a may include only one module connector, such as one tongue, or may have one or more module connectors in the form a groove configured to receive a corresponding tongue of a frame rail. A top wall 164 and a bottom wall 165 may extend rearward from the attachment wall 163. In the illustrated example, the top and bottom walls 164, 165 are angled inward toward one another, but it should be appreciated that in some examples they may have different orientations, such as parallel to one another. A rear wall 166 connects the top wall 164 and the bottom wall 165. In this regard, the four walls 163-166 of the strut module 162a form a hollow chamber 168 extending along the length of the strut module 162a. One or more fastener apertures 167 may extend through the attachment wall 163, from with the chamber 168. In some examples, one fastener aperture 167 may be positioned adjacent to each end of the strut module 162a for securing the module at its ends. In some examples, fastener apertures 167 may be positioned at pre-determined intervals along the length of the strut module 162a. Further, some fastener apertures 167 may extend through the top wall 164, as illustrated, or through the rear wall 166 or bottom wall 165 to provide tool access for installing a fastener through the attachment wall 163.

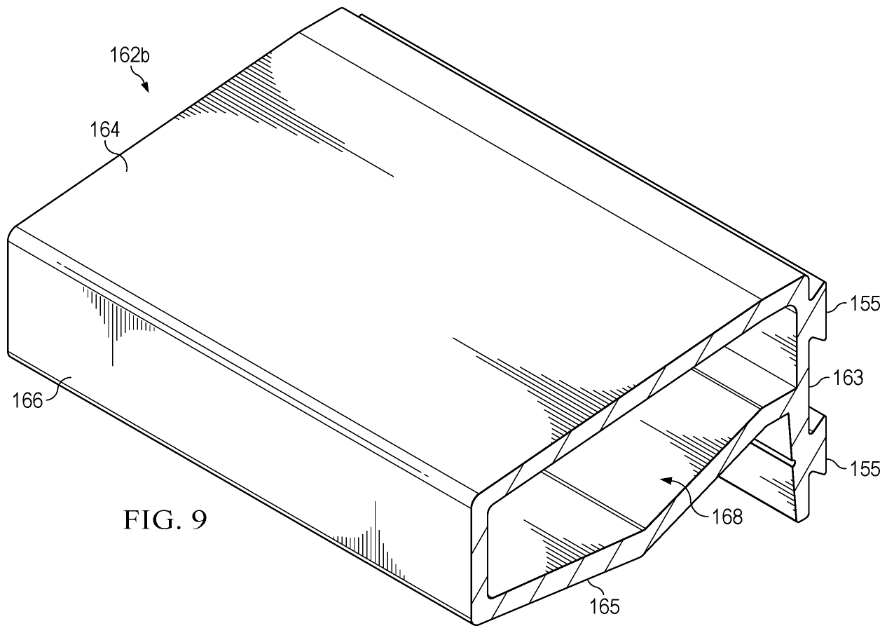

FIG. 9 illustrates a module 145 in the form of a strut module 162b. The strut module 162b includes an attachment wall 163 which includes module connectors in the form of tongues 155. The tongues 155 may each be sized and shaped for receipt in a corresponding module connector in the form of a groove in a frame rail. In some examples, the attachment wall 163 of the strut module 162b may include only one module connector, such as one tongue, or may have one or more module connectors in the form a groove configured to receive a corresponding tongue of a frame rail. A top wall 164 and a bottom wall 165 may extend rearward from the attachment wall 163. In the illustrated example, the bottom wall 165 is angled outward away from the top wall 164 for a portion of the depth of the module and is angled inward toward the top wall 164 for a portion of the depth of the module, forming a shallow V-shape in the bottom wall 165. It should be appreciated that in some examples the top and bottom walls 164, 165 may have different orientations, including additional or fewer changes in orientation through the depth. A rear wall 166 connects the top wall 164 and the bottom wall 165. In this regard, the four walls 163-166 of the strut module 162b form a hollow chamber 168 extending along the length of the strut module 162b. Although not illustrated, one or more fastener apertures 167 may extend through the attachment wall 163, from with the chamber 168.

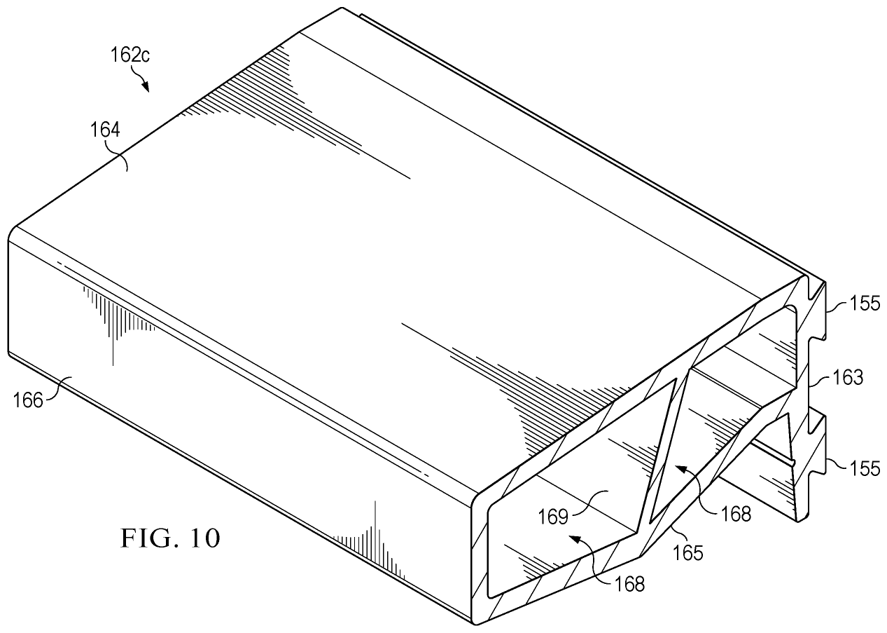

FIG. 10 illustrates a module 145 in the form of a strut module 162c. The strut module 162c includes an attachment wall 163 which includes module connectors in the form of tongues 155. The tongues 155 may each be sized and shaped for receipt in a corresponding module connector in the form of a groove in a frame rail. In some examples, the attachment wall 163 of the strut module 162d may include only one module connector, such as one tongue, or may have one or more module connectors in the form a groove configured to receive a corresponding tongue of a frame rail. A top wall 164 and a bottom wall 165 may extend rearward from the attachment wall 163. In the illustrated example, the bottom wall 165 is angled outward away from the top wall 164 for a portion of the depth of the module and is angled inward toward the top wall 164 for a portion of the depth of the module, forming a shallow V-shape in the bottom wall 165. It should be appreciated that in some examples the top and bottom walls 164, 165 may have different orientations, including additional or fewer changes in orientation through the depth. A rear wall 166 connects the top wall 164 and the bottom wall 165. In this regard, the four walls 163-166 of the strut module 162c form a hollow chamber 168 extending along the length of the strut module 162c. Although not illustrated, one or more fastener apertures 167 may extend through the attachment wall 163, from with the chamber 168. The strut module 162c includes a support wall 169 within the chamber 168. The support wall 169 may be formed as an integral component of the strut module 162c during extrusion or may be added thereafter. Although illustrated as being positioned at the change in orientation of the bottom wall 165 and angled forward toward the attachment wall 163, the support wall 169 may be placed at any suitable position within the chamber 168. Further, in some examples, the support wall 169 may be omitted and in some examples, one or more additional support walls 169 may be provided.

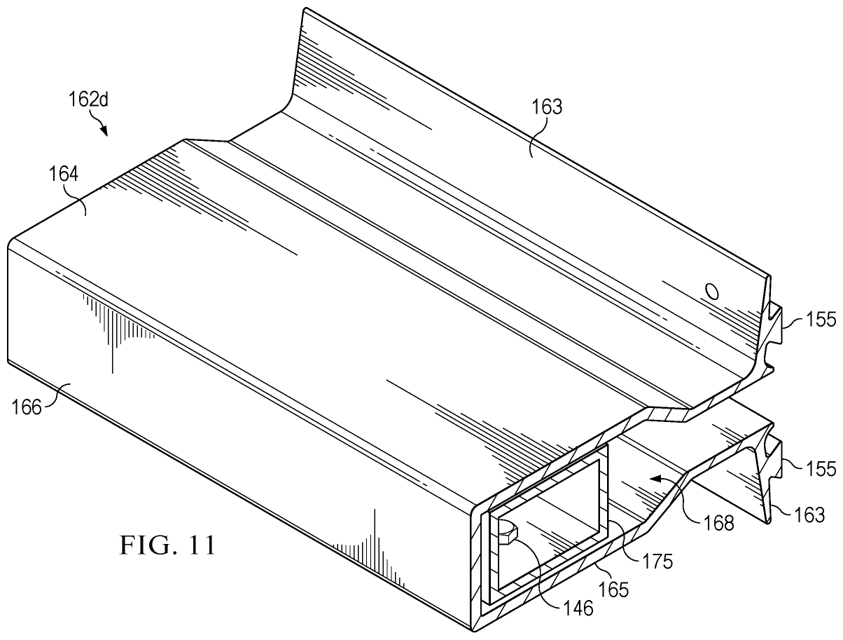

FIG. 11 illustrates a module 145 in the form of a strut module 162d. The strut module 162d includes an attachment wall 163 which includes module connectors in the form of tongues 155. The tongues 155 may each be sized and shaped for receipt in a corresponding module connector in the form of a groove in a frame rail. In some examples, the attachment wall 163 of the strut module 162d may include only one module connector, such as one tongue, or may have one or more module connectors in the form a groove configured to receive a corresponding tongue of a frame rail. In the illustrated example, the attachment wall 163 is split into an upper portion and a lower portion extending away from one another with a channel extending therebetween. A top wall 164 and a bottom wall 165 extend rearward from the upper portion and the lower portion of the attachment wall 163, respectively. In the illustrated example, the bottom wall 165 is parallel to the top wall 164 for a portion of the depth of the module, the top and bottom walls 164, 165 are then angled outward away from each other before returning to a parallel orientation. It should be appreciated that in some examples the top and bottom walls 164, 165 may have different orientations, including additional or fewer changes in orientation through the depth. A rear wall 166 connects the top wall 164 and the bottom wall 165. In this regard, the four walls 163-166 of the strut module 162d form a hollow chamber 168 extending along the length of the strut module 162d. One or more fastener apertures 167 may extend through one or both portions of the attachment wall 163. The strut module 162d includes an internal support member 175 within the chamber 168. The internal support member 175 may be formed as an integral component of the strut module 162d during extrusion or may be added thereafter. In the illustrated example, the internal support member 175 is formed as a separate component which can be inserted into the chamber 168 during assembly. The internal support member 175 is secured in the chamber 168 with one or more fasteners 146 extending through the internal support member 175 and the bottom wall 165, although the fasteners 146 extend through any suitable wall of the module. Although illustrated as having a rectangular cross-sectional shape corresponding to a portion of the chamber 168 having the greatest height, the internal support member 175 may have any suitable shape and may be made from any suitable material. In some examples, the internal support member 175 is made from the same material as the strut module 162d (e.g., aluminum) and in some examples it is made from a different material (e.g., steel). Advantageously, this design allows for concealing a strong but unsightly internal support member 175 within the strut module 162d. Further, in some examples, the internal support member 175 may be omitted and in some examples, one or more additional internal support members 175 may be provided.

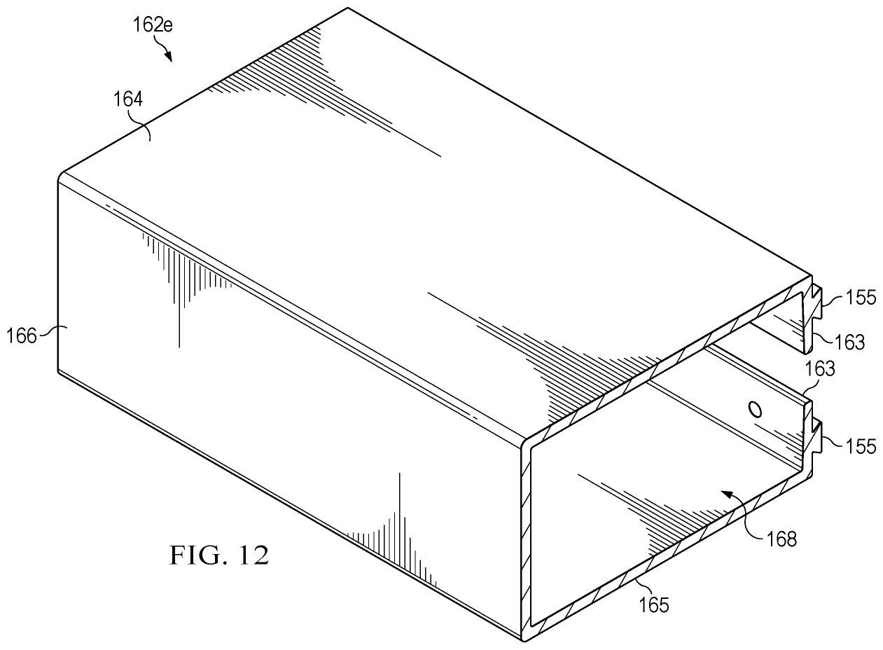

FIG. 12 illustrates a module 145 in the form of a strut module 162e. The strut module 162e includes an attachment wall 163 which includes module connectors in the form of tongues 155. The tongues 155 may each be sized and shaped for receipt in a corresponding module connector in the form of a groove in a frame rail. In some examples, the attachment wall 163 of the strut module 162e may include only one module connector, such as one tongue, or may have one or more module connectors in the form a groove configured to receive a corresponding tongue of a frame rail. In the illustrated example, the attachment wall 163 is split into an upper portion and a lower portion extending toward one another with a channel extending therebetween. A top wall 164 and a bottom wall 165 extend rearward from the upper portion and the lower portion of the attachment wall 163, respectively. In the illustrated example, the bottom wall 165 is parallel to the top wall 164. It should be appreciated that in some examples the top and bottom walls 164, 165 may have different orientations, including additional changes in orientation through the depth of the module. A rear wall 166 connects the top wall 164 and the bottom wall 165. In this regard, the four walls 163-166 of the strut module 162e form a hollow chamber 168 extending along the length of the strut module 162e. One or more fastener apertures 167 may extend through one or both portions of the attachment wall 163.

It should be appreciated that the modules 145 of FIGS. 7-12 are only some examples of modules contemplated in the present disclosure. Additional examples of modules 145 may include any suitable combinations of features of the described modules. For example, modules 145 described without an internal support member 175 or support wall 169, such as the strut module 162e, may include such added support features in some applications. Further, any modules 145 may include a single tongue 155, two tongues, 155, or three or more tongues 155. Similarly, any modules 145 may include a single groove 154, two grooves 154, or three or more grooves 154. Any modules may alternatively include a combination of one or more tongues 155 and one or more grooves 154 with a corresponding arrangement formed on a respective frame rail.

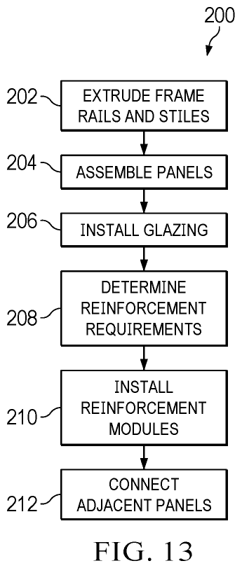

FIG. 13 illustrates an example of a method 200 for assembling a multi-panel door 100. At a process 202, frame rails and stiles are extruded from any suitable material such as aluminum. All frame rails may have the same extrusion thickness and may include no integral fins or struts. This allows fixturing to be standardized enabling easy setup for fabrication, assembly, and handling, resulting in reduced manufacturing and lead times. For example, shipping and handling costs may be reduced because the cross-sections of the frame rails will not include fins extending from the frame rails, allowing for compact packaging. Further, only a few different frame rail types may be needed in assembling a door, such as a bottom and top frame rail type, an intermediate top frame rail type, and an intermediate bottom frame rail type. In this regard, distributors may procure and retain a simplified inventory of parts from which they can assembly doors.

At a process 204, the panels of the door are assembled. This may include attaching outer stiles between frame rails as well as any appropriate number of intermediate stiles to create the desired number of openings.

At a process 206, glazing members may be installed into the openings of the panels. For example, the bottom edge of the glazing member 126 may be placed on the ledge 132 of an intermediate bottom frame rail and tilted into place against the lips 170 of the top and bottom intermediate frame rails. The coupling mechanism 150 may help temporarily retain the glazing member 126 in place while retainer members 152 are installed.

At a process 208, the reinforcement requires of the particular door may be determined. This may involve local or regional regulations and design standards for anticipate wind loads, as well as the specific materials used in the frame rails, stiles, and glazing members. For example, heavier materials and/or materials with lower strengths may require additional reinforcement. Specific reinforcement requirements may be determined for the whole door, on a panel by panel basis, or even different reinforcement requirements within a single panel. For example, a panel may require a strut module near its center but only fin modules near its lateral sides.

At a process 210, reinforcement modules are installed per the determined requirements. The modules (e.g., any module 145) may be slid onto a respective panel from a lateral side edge of its upper or lower frame rail. All panels within a door may utilize the same module type (e.g., fin module 160) or different panels within a door may utilize different module types (e.g., one or more fin modules 160, one or more strut modules 162a, and one or more strut modules 162b). If appropriate, one or more of the modules 145 may be fastened to the respective door panel with one or more fasteners to prevent lateral translation of the module 145.

Notably, due to the modular design of a door according to the present disclosure, if a customer decides shortly before or even during installation to make modifications to the door design, for example by upgrading to heavier glass glazing members or to accommodate a greater wind load, reinforcement modules 145 may be easily added or swapped out to accommodate the changes.

At process 212, the panels may be connected together to form the door. For example, hinges may be installed between adjacent panels and the door may be installed into the track.

It will be appreciated that the method 200 does not necessarily require the processes 202-212 to be performed in the illustrated order. For example, it is common for the panels to be connected (process 212) in the door tracks before installing the glazing members (process 206). As another example, the reinforcement modules may be installed on their respective frame rails (process 210) prior to assembling the panels (process 204).

The modularity of the frame rails and add-on reinforcement modules described in the present disclosure allows a reduced number of distinct components for assembling a door. This allows for simplified manufacturing, inventory management, shipping, and assembly. Additionally, the modules described herein may be extruded from aluminum which is generally more aesthetically appealing than current rolled steel struts that are secured with a large number of fasteners visible along the rear side of the door. Not only is aluminum generally more appealing, but the designs of the modules discussed herein may allow for use of a reduced number of fasteners as well as concealing the fasteners within the strut.

Although the examples herein are described primarily in the context of a multi-panel upward-acting sectional door, it will be appreciated that the concepts of the present disclosure may be applied to single-panel doors, sliding doors, windows, and the like.

Although the figures show relative positions of each component, the actual dimension and scale of each component may differ from the illustration and depend on particular production specifications.

In the foregoing description of certain examples, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. In the foregoing description of certain examples, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “outer” and “inner,” “upper” and “lower,” “first” and “second,” “internal” and “external,” “above” and “below” and the like are used as words of convenience to provide reference points and are not to be construed as limiting terms.

In addition, the foregoing describes only some examples of the concepts of the present disclosure, and alterations, modifications, additions and/or changes can be made thereto without departing from the scope and spirit of the disclosure, the examples being illustrative and not restrictive.

Also, the various examples described above may be implemented in conjunction with other examples, e.g., aspects of one example may be combined with aspects of another example to realize yet other examples. Further, each independent feature, component, or process of any given system or method may constitute an additional example.

Persons of ordinary skill in the art will appreciate that the implementations encompassed by the present disclosure are not limited to the particular example implementations described above. In that regard, although illustrative examples have been shown and described, a wide range of modification, change, combination, and substitution is contemplated in the foregoing disclosure. It is understood that such variations may be made to the foregoing without departing from the scope of the present disclosure. Accordingly, it is appropriate that the appended claims be construed broadly and in a manner consistent with the present disclosure.

What is claimed is:

1. A frame rail for a movable barrier, comprising:
a top side, a bottom side, a front side, and a rear side; and
a first module connector formed on the rear side, the first module connector extending along a length of the frame rail and configured to slidably receive a corresponding second module connector of a module.

2. The frame rail of claim 1, further comprising a third module connector formed on the rear side, the third module connector extending along the length of the frame rail parallel to the first module connector and configured to slidably receive a corresponding fourth module connector of the module.

3. The frame rail of claim 1, wherein the frame rail has a continuous cross-section with the first module connector integrally formed with the top, bottom, front, and rear sides.

4. The frame rail of claim 3, wherein the frame rail is formed as an extrusion.

5. The frame rail of claim 1, wherein one of the first or second module connectors comprises a groove and the other of the first or second module connectors comprises a tongue configured for receipt within the groove.

6. The frame rail of claim 5, wherein the groove and the tongue are shaped as a dovetail in cross-section.

7. The frame rail of claim 1, wherein first module connector is configured to slidably receive the second module connector from a longitudinal end surface of the frame rail.

8. A movable barrier, comprising:
a plurality of interconnected panels, a first panel of the plurality of interconnected panels comprising:
a first frame rail comprising:
a top side, a bottom side, a front side, and a rear side; and
a first module connector formed on the rear side, the first module connector extending along a length of the first frame rail;
a second frame rail; and
at least one stile connecting the first and second frame rails; and
a first module comprising a second module connector configured to slidably engage the first module connector to secure the first module to the first panel.

9. The movable barrier of claim 8, wherein the first module comprises a reinforcing fin configured to resist flexing of the first panel.

10. The movable barrier of claim 9, wherein one of the first or second module connectors comprises a groove and the other of the first or second module connectors comprises a tongue configured for receipt within the groove.

11. The movable barrier of claim 8, wherein the first frame rail further comprises a third module connector formed on the rear side, the third module connector extending along the length of the first frame rail parallel to the first module connector, and the first module further comprises a corresponding fourth module connector configured to slidably engage the third module connector to secure the first module to the first panel.

12. The movable barrier of claim 11, wherein:
the first module connector and the third module connector each comprise a groove and the second module connector and the fourth module connector each comprise a corresponding tongue; or
the first module connector and the third module connector each comprise a tongue and the second module connector and the fourth module connector each comprise a corresponding groove.

13. The movable barrier of claim 11, wherein the first module comprises a reinforcing strut configured to resist bending of the first panel.

14. The movable barrier of claim 13, wherein the strut comprises a chamber enclosed in cross-section extending along a length of the strut.

15. The movable barrier of claim 14, where the strut comprises a support wall positioned in the chamber and extending between a top wall of the strut and a bottom wall of the strut.

16. The movable barrier of claim 14, wherein the strut comprises an internal support member slidably receivable within the chamber.

17. The movable barrier of claim 8, wherein:
the second frame rail comprises:
a top side, a bottom side, a front side, and a rear side; and
a third module connector formed on the rear side of the second frame rail, the third module connector extending along a length of the second frame rail; and
the movable barrier further comprises:
a second module comprising a fourth module connector configured to slidably engage the third module connector to secure the second module to the first panel; and
a glazing member positioned within an opening formed by the first frame rail, the second frame rail, a first stile, and a second stile.

18. A method of assembling a movable barrier, comprising:
forming a plurality of panels, each panel of the plurality of panels comprising an opening defined between a first frame rail, a second frame rail, a first stile connecting the first and second frame rails, and a second stile connecting the first and second frame rails, wherein the first frame rail comprises:
a top side, a bottom side, a front side, and a rear side;
a module connector formed on the rear side, the module connector extending along a length of the first frame rail;
positioning a glazing member in the opening of each panel;
connecting each panel to one or more adjacent panels of the plurality of panels;
coupling a first module to a first panel of the plurality of panels by slidably engaging a module connector of the first module with the module connector of the first frame rail of the first panel; and
coupling a second module to a second panel of the plurality of panels by slidably engaging a module connector of the second module with the module connector of the first frame rail of the second panel.

19. The method of claim 18, wherein the first module has a different cross-sectional profile than the second module.

20. The method of claim 18, wherein coupling the first module to the first panel of the plurality of panels includes slidably engaging a second module connector of the first module with a second module connector of the first frame rail of the first panel.
